(19) United States
(12) Patent Application Publication
(10) Pub. No.: US 2019/0225010 A1
(43) Pub. Date: Jul. 25, 2019

(54) CAP MEMBER FOR WHEEL MOUNTING NUT, AND METHOD OF MOUNTING WHEEL

(71) Applicant: KYO-EI INDUSTRIAL CORPORATION, Osaka-shi (JP)

(72) Inventor: Daisaku KISHIDA, Osaka-shi (JP)

(73) Assignee: KYO-EI INDUSTRIAL CORPORATION, Osaka-shi (JP)

(21) Appl. No.: 15/951,179

(22) Filed: Apr. 12, 2018

(30) Foreign Application Priority Data
Jan. 22, 2018 (JP) 2018-008021

(51) Int. Cl. B60B 3/16; F16B 37/14; B60B 23/08

(52) U.S. Cl. CPC B60B 3/165; B60B 23/08; F16B 37/14

(57) ABSTRACT

Provided are: a cap member, which is applicable to a wheel mounting nut and is less likely to deteriorate its appearance even if attachment and removal thereof is repeated; and a method of mounting a wheel using the cap member. A cap member 1 includes: a shaft portion 11 provided with a male thread 11a to be screwed on a base end portion of a female thread 2a of a wheel mounting nut 2; and a cover portion 12 that is integrally formed with a base end of the shaft portion 11 and covers a base end opening of the wheel mounting nut 2. The shaft portion 11 is provided on a distal end thereof with a hexagonal hole 13, which serves as a tool engagement portion.

### CROSS-REFERENCE TO RELATED APPLICATIONS

The present application claims priority under 35 U.S.C. § 119 to Japanese Patent Application No. 2018-008021, filed Jan. 22, 2018, entitled “Cap Member for Wheel Mounting Nut, and Method of Mounting Wheel.” The contents of this application are incorporated herein by reference in their entirety.

### BACKGROUND OF THE INVENTION

### 1. Field of the Invention

The present invention relates to a cap member suitable for a wheel mounting nut that is used in mounting a wheel on a hub provided with hub bolts, and to a method of mounting a wheel using the cap member.

### 2. Description of the Related Art

Conventional wheel mounting structures come in two types: one is such that a hub is provided with hub bolts, and a wheel is mounted by tightening wheel mounting nuts on the hub bolts; and the other is such that a hub is provided with female screw portions and a wheel is mounted by tightening wheel mounting bolts on the female screw portions.

Japanese Utility Model Registration No. 3198543 discloses screwing a tubular cap member on a wheel mounting bolt.

### SUMMARY OF THE INVENTION

The cap member disclosed in Japanese Utility Model Registration No. 3198543 has an advantage in that it increases decorativeness of the wheel mounting bolt, but cannot be applied to a wheel mounting nut. In addition, there exists a problem that repetitive attachment and removal of the cap member causes flaws on the cap member, which deteriorates its appearance. Furthermore, there also exists a problem that the cap member deteriorates its appearance because it requires a portion having the shape of a hexagonal prism, which serves as a tool engagement portion for engaging a tool such as a socket wrench.

An object of the present invention is to provide: a cap member, which is applicable to a wheel mounting nut and is less likely to deteriorate its appearance even if attachment and removal of the cap member is repeated; and a method of mounting a wheel using the wheel mounting nut with the cap member.

### Solution to Problem

In accordance with the present invention, there is provided a cap member for a wheel mounting nut. The cap member is attached to a wheel mounting nut that is hollow and is screwed on a hub bolt thereby mounting a wheel. The cap member includes: a shaft portion provided with a male thread to be screwed on a base end portion of a female thread of the wheel mounting nut; and a cover portion that is integrally formed with a base end of the shaft portion and covers a base end opening of the wheel mounting nut. The shaft portion is provided on a distal end thereof with a tool engagement portion.

As the wheel mounting nut, a cap nut with a base end portion thereof being closed may not be used in the present invention. However, a wheel mounting nut of various type may be used as long as the base end portion has an opening. In addition to a common hexagonal nut, an antitheft nut having a non-hexagonal irregular cross section may be used.

The tool engagement portion is, for example, a hexagonal hole which can be used for turning the cap member with a hexagonal wrench, but is not limited thereto. The tool engagement portion is a bottomed hole having an appropriate non-circular cross section. A tool that can be engaged with the bottomed hole is used as a tool for turning the cap member. Instead of being turned from the cover portion side (not being fastened from above), the cap member may be turned with a tool having been inserted from the distal end side of the shaft portion (may be fastened from below).

The cover portion of the cap member is, for example, disc-shaped, and the outer diameter of the cover portion is slightly smaller than that of the wheel mounting nut.

In accordance with the present invention, there is provided a wheel mounting method of mounting a wheel by screwing a wheel mounting nut on a hub bolt. In this method, the cap member as described above is screwed on a wheel mounting nut that is hollow, in advance, and then, the wheel mounting nut having been integrated with the cap member is screwed on the hub bolt.

As compared to the conventional wheel mounting method, the wheel mounting method in accordance with the present invention requires an additional process of screwing the cap member on the wheel mounting nut in advance for integration. However, thereafter, a wheel may be mounted with the same process as the conventional process of screwing the wheel mounting nut, with which the cap member has been integrated, on a hub bolt.

There is no need to provide the cap member of the present invention on an outer periphery thereof with a hexagonal prism portion serving as a tool engagement portion, thereby increasing the decorativeness. In addition, even if the cap member is repetitively attached or removed, the cap member is less likely to be flawed, thereby preventing the impaired appearance.

### BRIEF DESCRIPTION OF DRAWINGS

A more complete appreciation of the invention and many of the attendant advantages thereof will be readily obtained as the same becomes better understood by reference to the following detailed description when considered in connection with the accompanying drawings, wherein:

FIG. 1 is a cutting-into-half cross sectional view showing the state where a cap member in accordance with the present invention is attached to a nut;

FIG. 2 is a perspective view showing an external appearance of the state where the cap member in accordance with the present invention is attached to the nut;

FIG. 3 shows a perspective cross sectional view of the nut in a state shown in FIG. 2;

FIG. 4 is a perspective view showing a method of attaching the cap member to the nut;

FIG. 5A is a front view of the cap member;

FIG. 5B is a back view of the cap member;

FIG. 5C is a left side view of the cap member;

FIG. 5D is a right side view of the cap member;

FIG. 5E is a top plan view of the cap member;

FIG. 5F is a bottom plan view of the cap member; and

FIG. 6 is a cross sectional view taken along line 6-6 of FIG. 5D.

### DESCRIPTION OF THE EMBODIMENTS

The embodiments of the present invention will be described below with reference to the accompanying drawings.

In the following description, a side closer to a hub (vehicle) on which a wheel is mounted is referred to as a distal end; and a side opposite to the distal end, that is, a side closer to an operator who performs a wheel mounting operation is referred to as a base end.

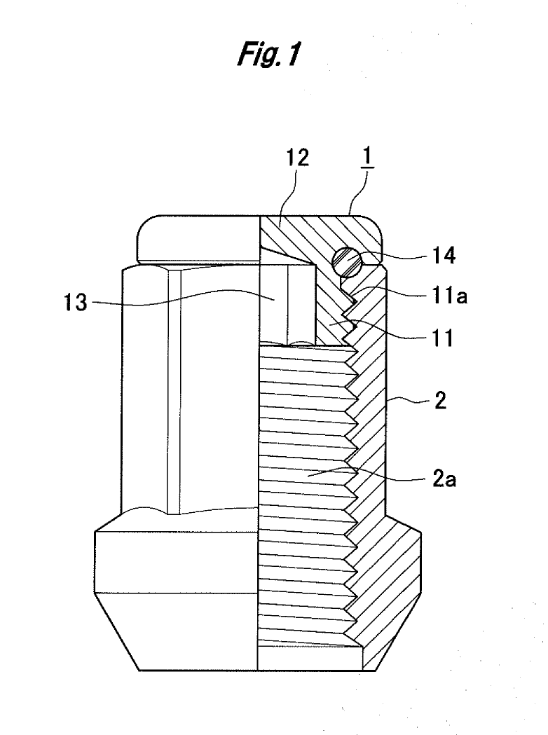

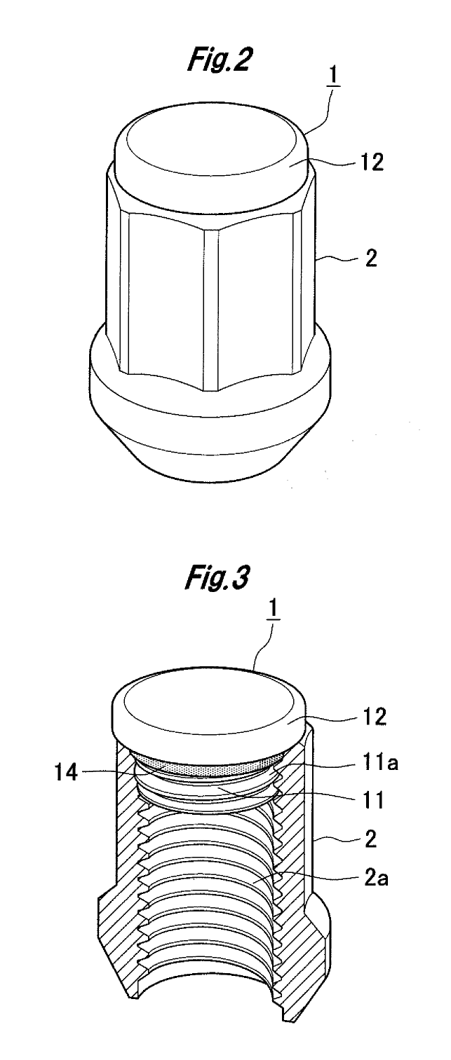

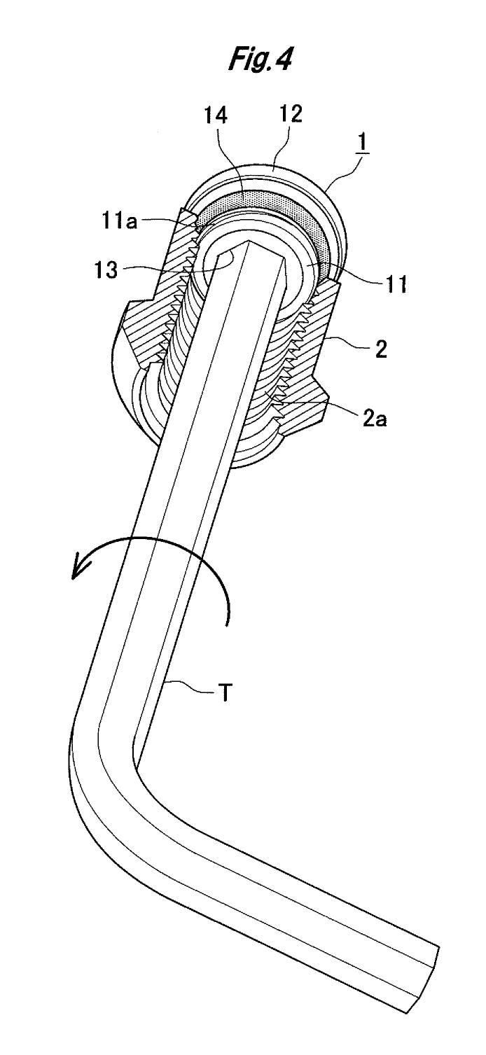

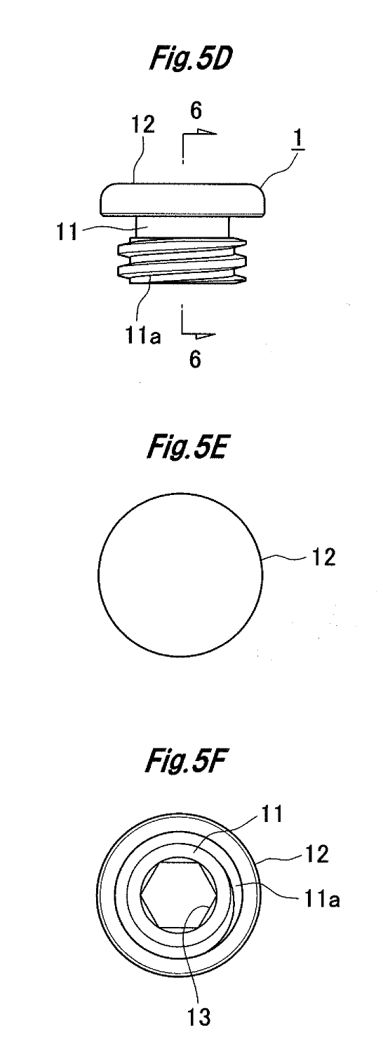

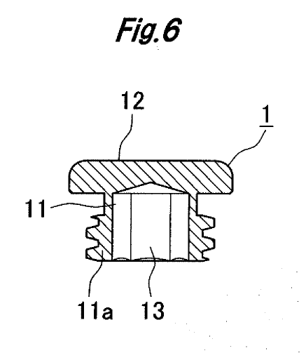

FIGS. 5A to 5F and FIG. 6 show an embodiment of a cap member in accordance with the present invention. FIG. 1 to FIG. 4 each show a state where the cap member is used.

As shown in FIG. 1 to FIG. 4, a cap member 1 is used by being attached to a base end of a wheel mounting nut 2 that is hollow, and includes: a shaft portion 11 provided with a male thread 11a to be screwed on a base end portion of a female thread 2a of the wheel mounting nut 2; and a cover portion 12 that is integrally formed with the shaft portion 11 and covers the base end of the wheel mounting nut 2.

The wheel mounting nut 2 is used to mount a wheel by being screwed on a hub bolt provided on a hub of an automobile. The wheel mounting nut 2 shown has a heptagonal cross section so as to be rotatable only with a dedicated tool, thereby having an antitheft function.

The shaft portion 11 is provided on a distal end thereof with a hexagonal hole (tool engagement portion) 13 into which a tool such as a hexagonal wrench T is fit.

An O-ring 14 is fit into a base end of the shaft portion 11. The O-ring 14 is interposed between a distal end surface of the cover portion 12 and a base end surface of the wheel mounting nut 2.

The cover portion 12 is disc-shaped and has an outer diameter slightly smaller than that of the wheel mounting nut 2.

The cap member 1 is made of an aluminum alloy, is colored red, blue, black, gold, etc., as appropriate, and has a print on it such as a logo, thereby increasing its decorativeness. The material, shape, and color of the cap member 1 are not specifically limited. For example, forming the cap member 1 from chromium molybdenum steel (SCM 435 forged steel stipulated in the Japanese Industrial Standards (JIS)) gives the cap member 1 improved strength and decorativeness at the same time.

The cap member 1 is attached to the wheel mounting nut 2 from the base end side. The cover portion 12 of the cap member 1 is turned manually whereby the male thread 11a of the shaft portion 11 is screwed on the base end portion of the female thread 2a of the wheel mounting nut 2 to be temporarily fixed.

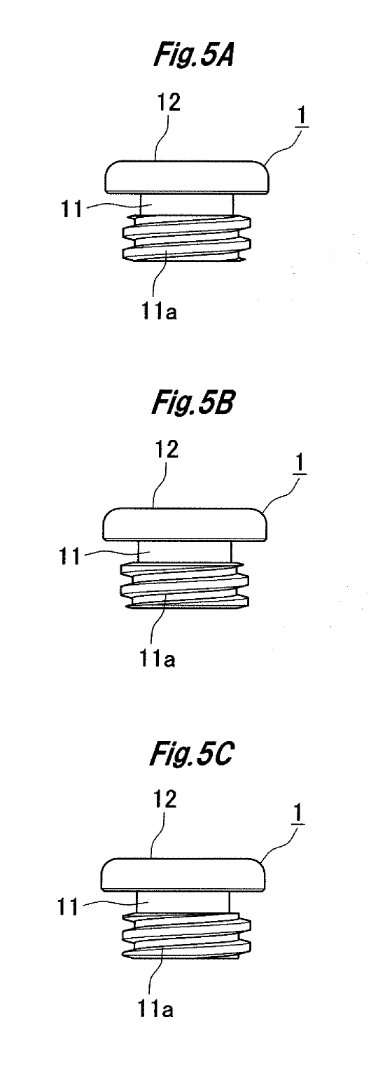

Then, as shown in FIG. 4, the cap member 1 is further turned with a hexagonal wrench T having been inserted from the distal end side of the wheel mounting nut 2, whereby the cap member 1 is securely fixed to the wheel mounting nut 2. Interposing the O-ring 14 between the cap member 1 and the wheel mounting nut 2 prevents the cap member 1 to be excessively tightened.

As described above, the cap member 1 is not turned from the cover portion 12 side (not fastened from above), but may be turned with the hexagonal wrench T (tool) inserted from the distal end side of the shaft portion 11 (fastened from below). The hexagonal hole 13 serving as a tool engagement portion may be a bottomed hole having an appropriate non-circular cross sectional shape instead of a hexagonal cross section. A tool that can be engaged with the bottomed hole is used as a tool for turning the cap member 1.

Because the outer diameter of the cover portion 12 is slightly smaller than the outer diameter of the wheel mounting nut 2, the wheel mounting nut 2 with the cap member 1 having been fixed thereto may be fastened using an impact wrench, etc., in the same manner as a nut to which no cap member 1 is attached.

Thus, as compared to the conventional wheel mounting method, the present invention requires an additional process of screwing a cap member 1 on the wheel mounting nut 2 in advance for integration. However, thereafter, a wheel may be mounted with the same process as the conventional process of screwing the wheel mounting nut 2, with which the cap member 1 has been integrated, on a hub bolt.

In a case where the cover portion 12 is provided with a hexagonal prism portion serving as a tool engagement portion to be engaged with a socket wrench, etc., the combined length of the cap member 1 and the wheel mounting nut 2 is increased. However, in the present invention, because the shaft portion 11 is provided with the tool engagement portion, the combined length of the cap member 1 and the wheel mounting nut 2 can be decreased. Moreover, because the cap member 1 is not provided with the hexagonal prism portion, the decorativeness of the cap member 1 is increased. Furthermore, when the cap member 1 is turned using the hexagonal wrench T, there is a possibility of the male thread 11a of the shaft portion 11 or the hexagonal hole 13 being flawed. However, because the shaft portion 11 is to be covered with the wheel mounting nut 2, turning the cap member 1 repetitively does not impair the appearance.

Here, because the wheel mounting nut 2 has a heptagonal cross section, the wheel mounting nut 2 cannot be fastened or removed with a general-purpose fastening tool and only those who have a dedicated tool can fasten or remove the wheel mounting nut 2, which prevents the wheel to be stolen.

It should be noted that the shape of the outer peripheral surface of the wheel mounting nut 2 may be a common hexagonal prism, may have an irregular humped shape instead of having a heptagonal shape, or may have a screw shape with oblique grooves, thereby providing an antitheft function.

### REFERENCE SIGNS LIST

1: cap member
2: wheel mounting nut
2a: female thread
11: shaft portion
11a: male thread
12: cover portion
13: hexagonal hole (tool engagement portion)
14: O-ring
T: hexagonal wrench

What is claimed is:

1. A cap member for a wheel mounting nut, the cap member to be attached to the wheel mounting nut that is hollow and is screwed on a hub bolt thereby mounting a wheel, the cap member comprising:
a shaft portion provided with a male thread to be screwed on a base end portion of a female thread of the wheel mounting nut; and
a cover portion that is integrally formed with a base end of the shaft portion and covers a base end opening of the wheel mounting nut,
the shaft portion being provided on a distal end thereof with a tool engagement portion.

2. A wheel mounting method of mounting a wheel by screwing a wheel mounting nut on a hub bolt, wherein the cap member according to claim 1 is screwed on a wheel mounting nut that is hollow, and then the wheel mounting nut thus integrated with the cap member is screwed on the hub bolt.
